(19) United States
(12) Patent Application Publication
(10) Pub. No.: US 2015/0206424 A1
(43) Pub. Date: Jul. 23, 2015

(54) WIRELESS MULTI-FUNCTION REMOTE CONTROL DEVICE

(71) Applicant: MOTOROLA SOLUTIONS, INC, SCHAUMBURG, IL (US)

(72) Inventors: Chi T Tran, Milwaukee, WI (US); Kok Tiong Lee, Sungai Petani (MY); Kuang Eng Lim, Sungai Petani (MY); Beng Gian Ooi, Gelugor (MY); Scott H Richards, Plantation, FL (US)

(21) Appl. No.: 14/414,027

(22) PCT Filed: Jul. 31, 2012
(86) PCT No.: PCT/MY2012/000219

§ 371 Date: Jan. 9, 2015

(51) Int. Cl. G08C 17/02; H04W 4/10; H04W 4/00

(52) U.S. Cl. CPC G08C 17/02; H04W 4/008; H04W 4/10

(57) ABSTRACT

A portable remote control device (100) for a radio is housed within a key fob housing (102). The key fob housing (102) camouflages a plurality of radio interface functions.

### FIELD OF THE INVENTION

The present invention relates generally to communication systems and more particularly to portable remote control devices providing an interface for a radio.

### BACKGROUND

Radio communication systems are often utilized by public safety personnel during undercover operations sometimes referred to as covert operations. The ability to conceal, camouflage and discreetly operate communication devices, such as two-way radios, presents many challenges to designers. Elements such as a small form factor, data security, and tamper resistance must be balanced with ease of accessibility and use. Two-way radios typically utilized by public safety personnel are often generally readily identifiable as official government or public safety type devices. The user's safety is also of paramount importance, and while the radio itself may be concealed, the user still needs access to the radio controls. A user interface which would allow discreet access to the radio is thus highly desirable.

Accordingly, there is a need for an improved user interface which permits remote access to the radio.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram of a remote control device for a radio in accordance with the various embodiments.

FIG. 2 shows the remote control device opened into first and second housing portions to access a plurality of control functions in accordance with the various embodiments.

FIG. 3 shows various interface capabilities provided by the remote control device in accordance with the various embodiments.

FIG. 4 shows the remote control device being utilized in a variety of environments in accordance with the various embodiments.

FIG. 5 shows the remote control device as part of a plurality of accessories for a radio in accordance with the various embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in apparatus components for a remote control device incorporating a plurality of wireless communication functions into a housing formed as a key fob, thereby enabling the remote control device to be used discreetly, such as in undercover communication applications. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

Briefly, in accordance with the various embodiments, there is provided herein a remote control device that integrates a plurality of radio interface functions and controls on both the outside and inside of a housing that camouflages the controls into a key fob form factor. The remote control device is highly advantageous to public safety personnel working in undercover operations.

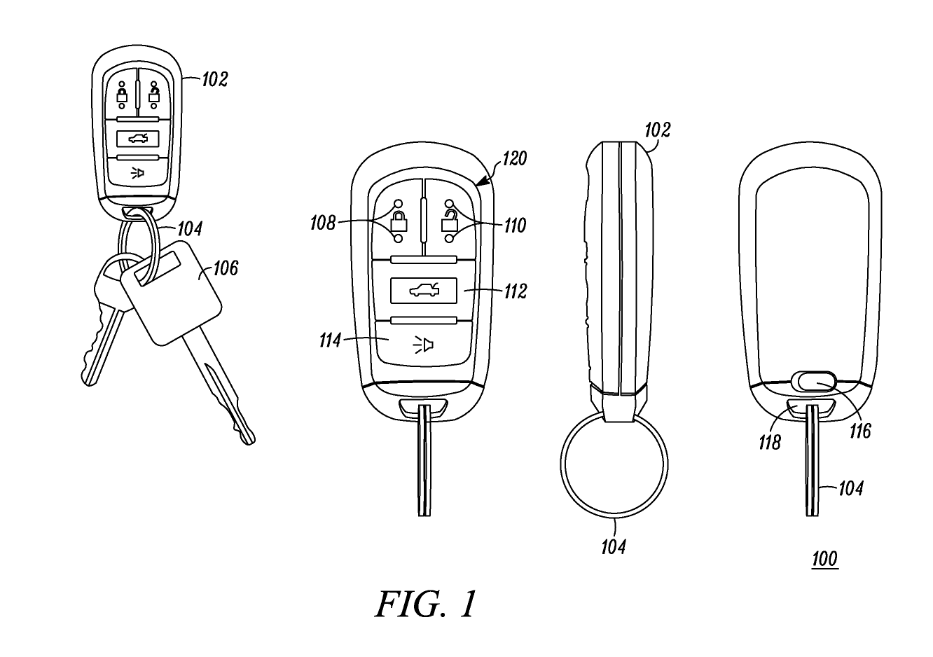

FIG. 1 is a remote control device 100 formed and operating in accordance with the various embodiments. Remote control device 100 provides a portable user interface for a handheld radio (shown later). The remote control device 100 comprises a housing 102 formed as a key fob and comprises a plurality of radio interface functions disposed upon and within the housing. The plurality of radio interface functions 120 comprises a plurality of buttons, such as buttons 108, 110, 112, 114 disposed on the housing 102, and in accordance with the various embodiments, the buttons are camouflaged by icon features typically associated with automotive key fob controls. The remote control device 100 takes the form of a key fob by further accommodating a key ring 104 and keys 106 through aperture 118.

In accordance with the various embodiments, the camouflaged buttons 108, 110, 112, 114 provide radio control functions. Button 108, camouflaged as a lock button, provides volume up/down control. Button 110, camouflaged as an unlock button, provides channel up/down control. Button 112, camouflaged as a trunk release button, provides push-to-talk (PTT) functionality. Button 114, camouflaged as an alarm button, provides programming capability. All of these functions are programmable and can thus be changed or modified per the user's radio applications.

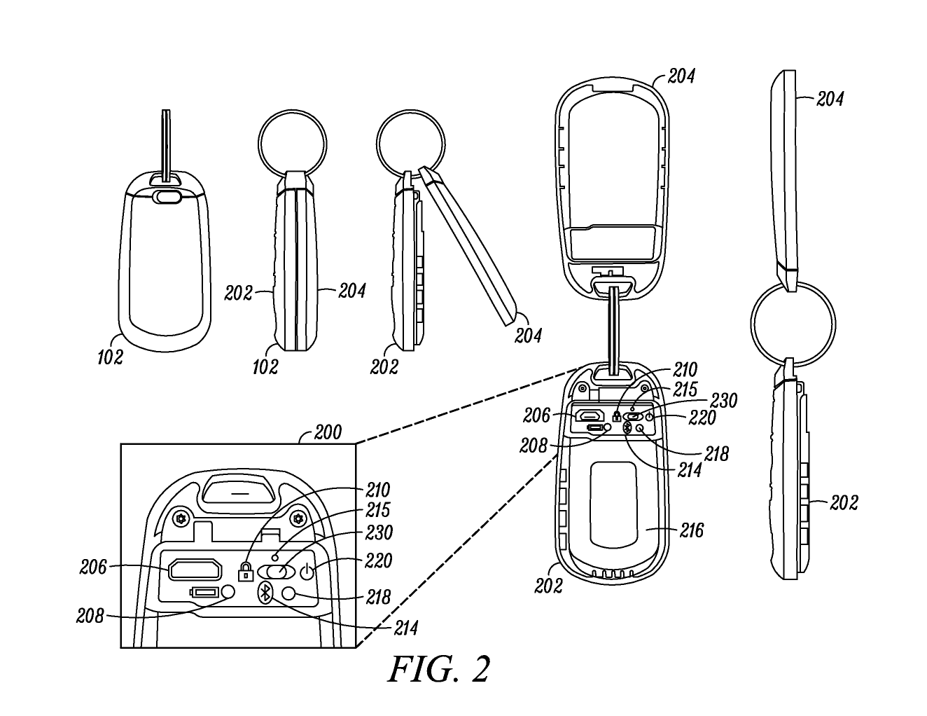

FIG. 2 shows the remote control device 100 opened into first and second housing portions 202, 204 allowing access to the plurality of radio interface functions which are disposed within the housing 102. The plurality of radio interface functions disposed within the housing will be referred t as a plurality of radio controls 200. Thus, the plurality of radio interface functions 120 are disposed both on the housing 102 as buttons 108, 110, 112, 114 and within the housing 102 as the plurality of radio controls 200.

First housing portion 202 houses the radio controls 200. The plurality of controls 200 comprises a micro universal serial bus (USB) jack 206 and an LED 208 providing a battery status indicator for a battery 216. Controls 200 further comprise a slideable switch 230 which slides between a lock position 210, an unlock position 215, and power on/off position 220. This switch 230 enables programming features when unlocked, and only permits push-to-talk (PTT) and volume control functionality during feature lock. Additional control features comprise a pairing indicator 214 and a blue dot 218 for Bluetooth pairing.

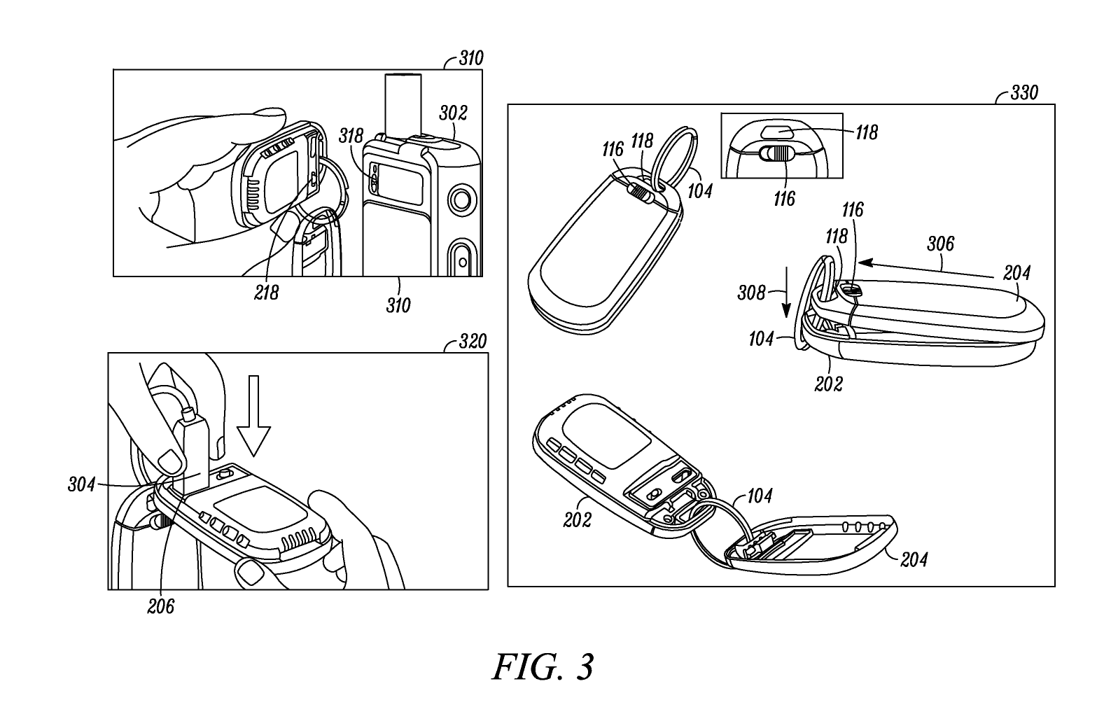

FIG. 3 shows various interface capabilities provided by the remote control device 100 in accordance with the various embodiments. Referring to 310, for pairing the remote control device 100 to radio 302, both the radio and remote control device are powered ON and in pairing mode. To enter the wireless pairing mode on the remote control device, the user presses and holds the trunk button 112 while powering up the remote control device. The blue dot 218 is placed in alignment with a corresponding dot 318 on the radio 302. A “wireless link connected” indication is provided at the radio 302 upon successful link establishment. At 320, the portable remote control device 100 is shown being charged via charger input 304 at jack 206.

FIG. 3 further shows at 330, the slide switch 116 located on the second housing portion 204 being slid in a first direction to separate the two housing portions at the key ring 104. Separating the two housing portions 202, 204 in this reverse clam shell manner, is counter intuitive to most key fob users and thus provides an extra level of tamper resistance. The housing 102 can be reassembled by coupling base portions of housing 202, 204 along a length 306 of the housing and then pressing 308 top portions of the housing together to join and form the aperture 118 for key ring 104. The slide switch 116 is then slid in a second, opposite direction to lock the two housing portions 202, 204 together as housing 102. Thus, the two housing portions 202, 204 remain attached to the key ring 104 even when the two housing portions 202, 204 are separated.

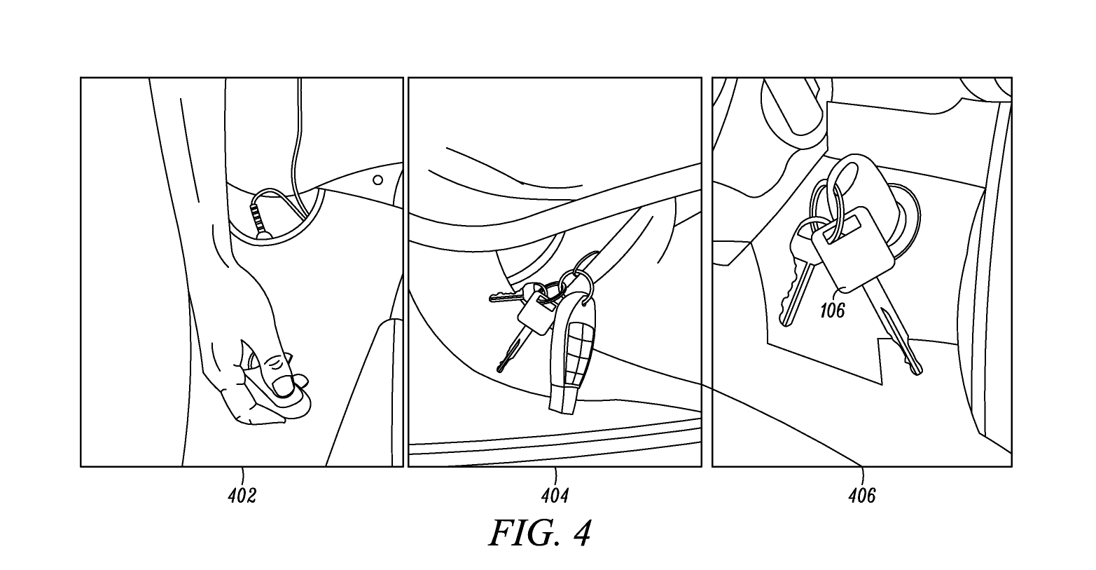

FIG. 4 shows the remote control device 100 being utilized in a variety of environments in accordance with the various embodiments. The housing 102 is sized to fit in the palm of a user's hand 402, where the buttons disposed on the housing 102 are readily accessible. The remote control device 100 fits easily into a pocket 404. And, the remote control device is well camouflaged when the keys 106 are inserted into a vehicle ignition.

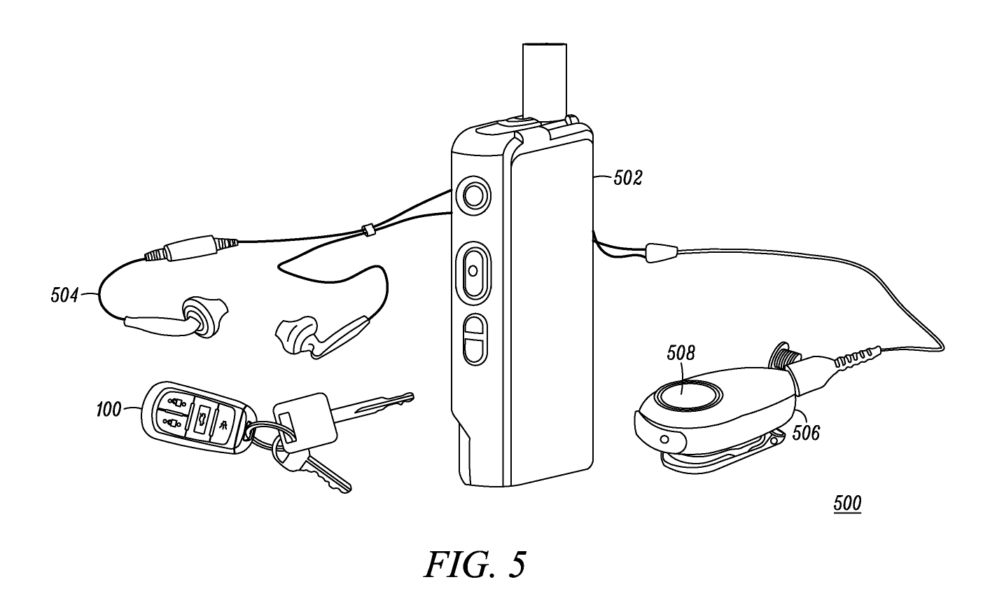

FIG. 5 shows the remote control device 100 as part of a plurality of accessories for a radio 502 in accordance with the various embodiments. Radio 502 is preferably a public safety radio for operating within a public safety radio communications network. The radio accessories for such a radio may comprise for example, ear buds 504 and remote push-to-talk (PTT) 508. The remote control device 100 operates as a wireless accessory for the radio 502 while providing the appearance of a car key fob. A user of radio 502 is thus presented with a variety of accessories which facilitate remote access and control of radio functions. The remote control device 100 providing a camouflaged form of a key fob greatly facilitates the user's ability to access radio functions discreetly.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A portable remote control device for a radio, comprising:
a housing formed as a key fob; and
a plurality of radio interface functions integrated and accessible at the key fob, the plurality of radio interface functions providing remote control of the radio.

2. The portable remote control device of claim 1, further comprising:
a plurality of buttons on the housing;
identifiers disposed on the buttons, the identifiers indicating non-radio functions; and
the plurality of buttons providing remote control to the radio.

3. The portable remote control device of claim 3, wherein the identifiers indicating non-radio functions comprise automotive indicators.

4. The portable remote control device of claim 1, wherein the radio comprises a public safety radio.

5. The portable remote control device of claim 1, wherein the radio comprises a two-way radio with PTT functionality.

6. The portable remote control device of claim 1, wherein the plurality of radio interface functions comprises: a radio power switch, BLUETOOTH pairing LED for programming the radio, USB charging for the radio and battery status LED for the radio.

7. The portable remote control device of claim 1, further comprising:
programmable buttons configured for radio operation, the programmable buttons having identifiers disposed on the housing indicating automotive controls.

8. The portable remote control device of claim 7, wherein the programmable buttons control volume up/down, channel up/down, PTT, and programming.

9. The portable remote control device of claim 8, wherein the identifiers disposed on the housing comprises, lock, unlock, trunk, and alarm.

10. The portable remote control device of claim 1, wherein the housing comprises first and second housing portions, the first housing portion being removable from the second housing portion to access the BLUETOOTH pairing LED with the radio.

11. The portable remote control device of claim 1, wherein the housing comprises first and second housing portions, the first housing portion being removable from the second housing portion to access a charging port within the housing.

12. The portable remote control device of claim 1, further comprising:
a key ring coupled through an opening of the housing; and
wherein the housing comprises first and second housing portions, the second housing portion having a slideable lock for opening the housing into the first and second housing portions;
the housing being flipped open by sliding the lock, separating the first and second housing portions at the opening of the key ring, and sliding the second housing portion downward from the key ring.

13. The portable remote control device of claim 1, wherein the housing is sized to fit in the palm of a user's hand.

14. The portable remote control device of claim 1, further comprising a plurality of control features accessible within the first housing portion, the plurality of control features comprising:
a universal serial bus (USB) jack;
an LED providing a battery status indicator;
a slideable switch that slides between a lock position, an unlock position, and a power on/off position;
a pairing indicator; and
a blue dot for Bluetooth pairing.

15. The portable remote control device of claim 1, wherein the plurality of radio interface functions are disposed both on the housing and within the housing.

16. The portable remote control device of claim 15, wherein the plurality of radio interface functions disposed on the housing are camouflaged by icon features associated with automotive key fob controls.

17. A wireless accessory for a portable radio, the accessory comprising a portable remote control device camouflaged as a key fob.

18. The wireless accessory for a portable radio of claim 17, wherein the portable remote control device comprises:
a housing having a plurality of buttons disposed thereon and camouflaged as automotive controls, the plurality of buttons providing remote control of the radio; and
a plurality of radio controls accessible inside the housing.

19. The wireless accessory of claim 18, wherein the housing has an aperture for a key ring, and the housing separates at the aperture to access the plurality of radio controls inside the housing while remaining coupled to the key ring.

20. The wireless accessory of claim 17, wherein the radio is a public safety radio operating within a public safety radio communications network.
